(19) United States
(12) Patent Application Publication
(10) Pub. No.: US 2014/0198006 A1
(43) Pub. Date: Jul. 17, 2014

(54) ANTENNA DEVICE

(71) Applicant: MURATA MANUFACTURING CO., LTD., Kyoto-fu (JP)

(72) Inventor: Shinichi NAKANO, Nagaokakyo-shi (JP)

(73) Assignee: MURATA MANUFACTURING CO., LTD., Kyoto-fu (JP)

(21) Appl. No.: 14/178,192

(22) Filed: Feb. 11, 2014

Related U.S. Application Data
(63) Continuation of application No. PCT/JP2013/051243, filed on Jan. 23, 2013.

(30) Foreign Application Priority Data
Feb. 2, 2012 (JP) 2012-020440

(51) Int. Cl. H01Q 7/06

(52) U.S. Cl. CPC H01Q 7/06
USPC 343/788

(57) ABSTRACT

A booster antenna having an aperture and a slit extending from the aperture to a distal end portion H, and a feeding coil having a coil conductor wound around a magnetic core. At least a part of an opening of the coil conductor is disposed at a position overlapping with the aperture of the booster antenna in plan view. The coil conductor is wound around the magnetic core such that a first conductor part disposed on a first surface of the magnetic core and a second conductor part disposed on a second surface of the magnetic core are located at different positions in plan view. The feeding coil is disposed such that the first surface faces the booster antenna and the first conductor part is disposed close to the distal end portion H of the booster antenna.

### CROSS REFERENCE TO RELATED APPLICATIONS

This application claims benefit of priority to Japanese Patent Application No. 2012-020440 filed on Feb. 2, 2012, and to International Patent Application No. PCT/JP2013/051243 filed on Jan. 23, 2013, the entire content of each of which is incorporated herein by reference.

### TECHNICAL FIELD

The present technical field relates to an antenna device for use in an RFID system or a short-range wireless communication system that performs communication with the other apparatus through electromagnetic signals.

### BACKGROUND

In NFC (Near Field Communication) systems that have recently been in widespread use, to perform communication between portable electronic apparatuses, such as cellular phones, or between a portable electronic apparatus and a reader/writer, a coil antenna for communication is sometimes mounted in each apparatus. A planar coil antenna has the highest magnetic field strength and can obtain a long communication distance in a normal direction of an aperture plane (in a winding axis direction). However, the magnetic field strength decreases with an increasing distance from the normal direction, and the planar coil antenna hardly performs radiation and does not have good communication characteristics in a direction parallel to the aperture plane.

Japanese Patent No. 4414942 discloses an antenna device that can perform magnetic field radiation even in a direction parallel to an aperture plane. FIG. 17 schematically illustrates the antenna device described in Japanese Patent No. 4414942. FIG. 18 is a cross-sectional view taken along line A-A of FIG. 17. An antenna device 100 described in Japanese Patent No. 4414942 includes a loop coil 101 formed by winding a conductive wire in a plane, and magnetic bodies 102A and 102B. The loop coil 101 extends long in one direction. The magnetic body 102A is disposed on one longitudinal side of the loop coil 101, and the magnetic body 102B is disposed under the other longitudinal side. The loop coil 101 has an insertion hole through which the magnetic bodies 101A and 101B are inserted. The magnetic bodies 102A and 102B are coupled and integrated by a coupling portion 102C in the insertion hole of the loop coil 101.

### SUMMARY

### Technical Problem

FIG. 19 includes schematic views illustrating directivity of the antenna device described in Japanese Patent No. 4414942. FIG. 19A illustrates directivity in a direction perpendicular to principal surfaces of the magnetic bodies 102A and 102B (a 0°-direction), FIG. 19B illustrates directivity in a direction parallel to the principal surfaces of the magnetic bodies 102A and 102B (a 90°-direction), FIG. 19C illustrates directivity in a direction tilted at an angle of −45° to the direction perpendicular to the principal surfaces of the magnetic bodies 102A and 102B (a direction tilted downward at an angle of −45° to a side opposite from the 90°-direction), and FIG. 19D illustrates directivity in a direction tilted at an angle of 45° to the direction perpendicular to the principal surfaces of the magnetic bodies 102A and 102B. A substantial direction of a winding center axis of the loop coil 101 in the antenna device described in Japanese Patent No. 4414942 is tilted in the −45°-direction (a direction tilted from the 0°-direction to the left side of the plane of the figure). For this reason, it is possible to obtain directivity in the 0°-direction of FIG. 19A, in the 90°-direction of FIG. 19B, and the −45°-direction of FIG. 19C. However, in the 45°-direction of FIG. 19D, a magnetic line of force does not pass through the loop coil 101 like a magnetic line of force A or partly passes through the loop coil 101 like a magnetic line of force B, but is cancelled by a magnetic line of force C from an opposite direction. Hence, it is difficult to ensure good communication.

Accordingly, an object of the present invention is to provide an antenna device and an electronic apparatus that can ensure the maximum communication distance at a wide angle.

### Solution to Problem

An antenna device according to the present invention includes a metallic member having a cutout that opens outside from at least one end portion, and an antenna coil including a magnetic core having a first surface and a second surface opposed to each other, and a coil conductor wound around the magnetic core. At least a part of an opening of the coil conductor is disposed at a position overlapping with the cutout of the metallic member in a normal direction of the first surface and the second surface. The coil conductor includes a first conductor part located on the first surface of the magnetic core, and a second conductor part located on the second surface of the magnetic core. The first conductor part and the second conductor part are wound around the magnetic core such as to be located at different positions in the normal direction of the first surface and the second surface. The antenna coil is disposed such that the first surface faces the metallic member and the first conductor part is located closer to the one end portion of the metallic member than the second conductor part.

This configuration allows a magnetic field of the coil conductor to be efficiently radiated by the metallic member. When magnetic field coupling is provided between the coil conductor and the metallic member, current flows along a peripheral edge of the cutout that opens outside from the one end portion of the metallic member, and further flows along a peripheral edge of the metallic member. A direction in which the current flows along the peripheral edge of the metallic member is the same as a direction in which the current flows through the coil conductor, and a magnetic field is produced from the metallic member in the same direction as a direction of a magnetic field from the coil conductor. By virtue of such formation of the cutout, the metallic member functions as an antenna that amplifies the magnetic field of the coil conductor, that is, a so-called booster antenna. Further, since the magnetic field from the metallic member is also radiated from the cutout, directivity in a forming direction of the cutout can be improved. Therefore, the magnetic field can also be radiated in a 45°-direction in addition to a 0°-direction, a 90°-direction, and a −∵°-direction, and an antenna device having high directivity at a wide angle can be obtained. Since the metallic member also functions as the booster antenna, as described above, the maximum communication distance in the 0°-direction, the 90°-direction, and the −∵°-direction can be increased.

The cutout may include an aperture and a first slit extending from the aperture to the one end portion.

With this configuration, the current density in the slit is increased, for example, by making the width of the slit less than the width of the aperture, and this can improve directivity in a direction of the slit.

Preferably, a distance L1 from the first conductor part to the one end portion is shorter than a distance L2 from the second conductor part to the other end portion opposed to the one end portion.

With this configuration, the antenna coil can be located closer to the one end portion of the metallic member, and communication efficiency of the antenna coil at the one end portion can be enhanced. That is, when the antenna coil is located closer to the one end portion of the metallic member, the length of the cutout (slit) relatively decreases. Hence, the density of current flowing near the cutout (slit) increases. This can further improve directivity in the direction of the cutout (slit).

The metallic member and the antenna coil may be integrated.

With this configuration, since the antenna coil can be located closer to the metallic member, radiation efficiency of the metallic member can be enhanced further. Also, since integration can reduce characteristic variations, for example, the resonant frequency of the antenna device can be designed easily.

The metallic member may further include a second slit connected to the cutout.

With this configuration, since the second slit is formed, directivity in a forming direction of the second slit can be obtained.

The antenna device may include a housing that contains the antenna coil and that is partly or entirely formed by a metallic portion. The metallic member may be the metallic portion of the housing.

With this configuration, when the housing is partly or entirely formed of metal, the necessity of preparing a separate metallic member is eliminated by utilizing a part or the entirety of the housing as the metallic member.

### Advantageous Effects of Invention

According to the present invention, since the metallic member can be caused to function as a booster antenna by forming the cutout in the metallic member, the strength of an electromagnetic field produced from the coil conductor can be increased. Further, since the first conductor part is disposed close to the one end portion of the metallic member, the magnetic field is mainly radiated from the cutout. Hence, directivity in the forming direction of the cutout, that is, in the 45°-direction can be improved.

### BRIEF DESCRIPTION OF THE DRAWINGS

FIG. 1 is a cross-sectional side view of a communication terminal apparatus including an RFID antenna according to a first embodiment.

FIG. 2 is a perspective view of a feeding coil.

FIG. 3 is a perspective view of the RFID antenna according to the first embodiment.

FIG. 4 is a cross-sectional view taken along line IV-IV of FIG. 3.

FIG. 5 illustrates an example of a path of current flowing through a coil conductor of the feeding coil and a booster antenna.

FIG. 6 schematically illustrates directivity directions of the RFID antenna.

FIG. 7 illustrates the magnetic field strength of the feeding coil when the booster antenna is not provided.

FIG. 8 illustrates the magnetic field strength of the feeding coil when the booster antenna is provided.

FIG. 9 illustrates a modification of an RFID antenna in which a slit is further formed in a booster antenna to further improve directivity.

FIG. 10 illustrates a modification of an RFID antenna in which a slit is further formed in a booster antenna to further improve directivity.

FIG. 11A illustrates the magnetic field strength of the feeding coil illustrated in FIG. 8.

FIG. 11B illustrates the magnetic field strength of a feeding coil in the RFID antenna illustrated in FIG. 9.

FIG. 11C illustrates the magnetic field strength of a feeding coil in the RFID antenna illustrated in FIG. 10.

FIG. 12A schematically illustrates a modification of a booster antenna.

FIG. 12B schematically illustrates a modification of a booster antenna.

FIG. 12C schematically illustrates a modification of a booster antenna.

FIG. 12D schematically illustrates a modification of a booster antenna.

FIG. 13A schematically illustrates a modification of a booster antenna.

FIG. 13B schematically illustrates a modification of a booster antenna.

FIG. 13C schematically illustrates a modification of a booster antenna.

FIG. 13D schematically illustrates a modification of a booster antenna.

FIG. 14 illustrates another example of an RFID antenna according to the first embodiment.

FIG. 15 is a perspective view of an RFID antenna according to a second embodiment.

FIG. 16 is a perspective view of an RFID antenna according to a third embodiment.

FIG. 17 schematically illustrates an antenna device described in Japanese Patent No. 4414942.

FIG. 18 is a cross-sectional view taken along line A-A of FIG. 17.

FIG. 19A schematically illustrates directivity of the antenna device described in Japanese Patent No. 4414942.

FIG. 19B schematically illustrates directivity of the antenna device described in Japanese Patent No. 4414942.

FIG. 19C schematically illustrates directivity of the antenna device described in Japanese Patent No. 4414942.

FIG. 19D schematically illustrates directivity of the antenna device described in Japanese Patent No. 4414942.

### DETAILED DESCRIPTION

In the below-described embodiments, an antenna device according to the present invention will be described as an RFID antenna.

### First Embodiment

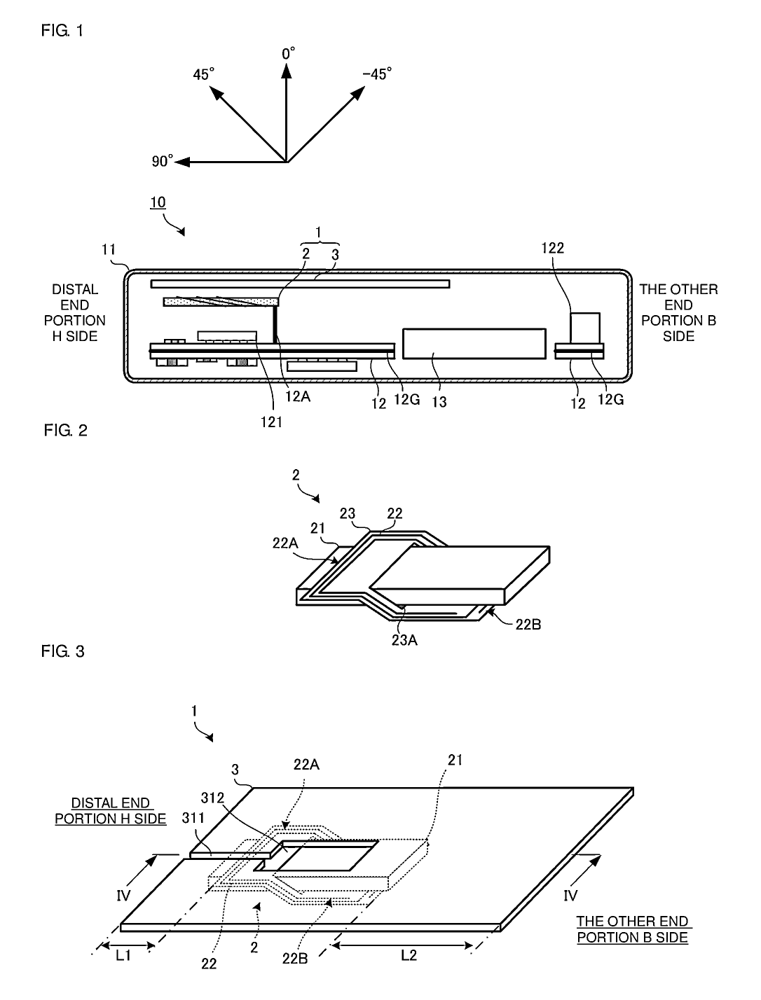

FIG. 1 is a cross-sectional side view of a communication terminal apparatus including an RFID antenna according to a first embodiment. Here, a left side of the plane of FIG. 1 is a distal end portion (one end portion in the present invention) H of a communication terminal apparatus 10, a right side of the plane of FIG. 1 is the other end portion (the other end portion in the present invention) B of the communication terminal apparatus 10 to be grasped by a user, and a direction extending between the distal end portion H and the other end portion B is referred to as a longitudinal direction of the communication terminal apparatus 10. Further, a lower side of the plane of FIG. 1 is a front side of the communication terminal apparatus 10 where an input unit, a display unit, etc. are provided, and an upper side of the plane of FIG. 1 is a back side of the communication terminal apparatus 10. A normal direction of the back side is a 0°-direction, and the longitudinal direction parallel to the back side is a 90°-direction. A direction tilted from the 0°-direction to the left side of the plane is a 45°-direction.

The communication terminal apparatus 10 includes a housing 11 formed of, for example, insulating resin. In the housing 11, a board (printed board) 12, a battery pack 13, etc. are incorporated. A ground conductor pattern 12G is provided in an inner layer of the board 12, and multiple mount components, such as a feeding circuit 121 and a cellular phone antenna 122, are mounted on front and back surfaces of the board 12. In this embodiment, the board 12 is mainly composed of two substrates, that is, a substrate on which the cellular phone antenna 122 is mounted, and a substrate on which an IC chip that forms the feeding circuit 121 is mounted. These two substrates are electrically coupled, for example, by an unillustrated coaxial cable or stripline cable. The cellular phone antenna 122 is a chip antenna in which a radiation electrode is provided on an outer surface of a dielectric block, and is disposed near the other end portion B of the housing 11. For example, the cellular phone antenna 122 performs communication using a band of 700 MHz to 2.7 GHz. Since metallic components (for example, the battery pack 13) are interposed between the cellular phone antenna 122 and a below-described RFID antenna 1, these antennas rarely interfere with each other, and antenna characteristics thereof are ensured.

An RFID antenna (an antenna device in the present invention) 1 is disposed on an inner back side of the housing 11. The RFID antenna 1 is an antenna for an RFID system using an HF band, for example, of 13.56 MHz. The RFID antenna 1 of this embodiment is configured to improve gain in the 0°-direction, the 90°-direction, and the 45°-direction.

The RFID antenna 1 includes a feeding coil (an antenna coil in the present invention) 2 and a booster antenna 3 formed by a metallic member. The metallic member is formed by a metallic thin plate such as a metallic film or metallic foil. The feeding coil 2 is disposed in the distal end portion H of the communication terminal apparatus 10, and is coupled by a feeding pin 12A to the feeding circuit 121 mounted on the board 12. The booster antenna 3 is disposed between a back surface of the communication terminal apparatus 10 and the feeding coil 2, for example, to be in contact with the housing 11, and makes electromagnetic field coupling (mainly, magnetic field coupling) with the feeding coil 2.

FIG. 2 is a perspective view of the feeding coil 2. The feeding coil 2 includes a magnetic core 21 and a coil conductor 22 wound around the magnetic core 21. The magnetic core 21 is formed by shaping a hybrid of ferrite powder and a resin material into a rectangular plate, or is formed by a sintered ferrite plate. The magnetic core 21 has first and second surfaces each shaped like a rectangle that extends long in one direction. The first surface and the second surface are two parallel surfaces of the magnetic core 21 having the largest area.

The coil conductor 22 is provided on a flexible substrate 23. In a part of an opening of the coil conductor 22 and in almost the center portion of the flexible substrate 23, a through hole 23A penetrates the flexible substrate 23 in a thickness direction. The magnetic core 21 is inserted in the through hole 23A. At this time, a part of the coil conductor 22 is located on the first surface of the magnetic core 21, and another part thereof is located on the second surface of the magnetic core 21. Hereinafter, the part of the coil conductor 22 located on the first surface is referred to as a first conductor part 22A, and the part of the coil conductor 22 located on the second surface is referred to as a second conductor part 22B. Both ends of the coil conductor 22 are coupled as input and output terminals to the feeding circuit 121.

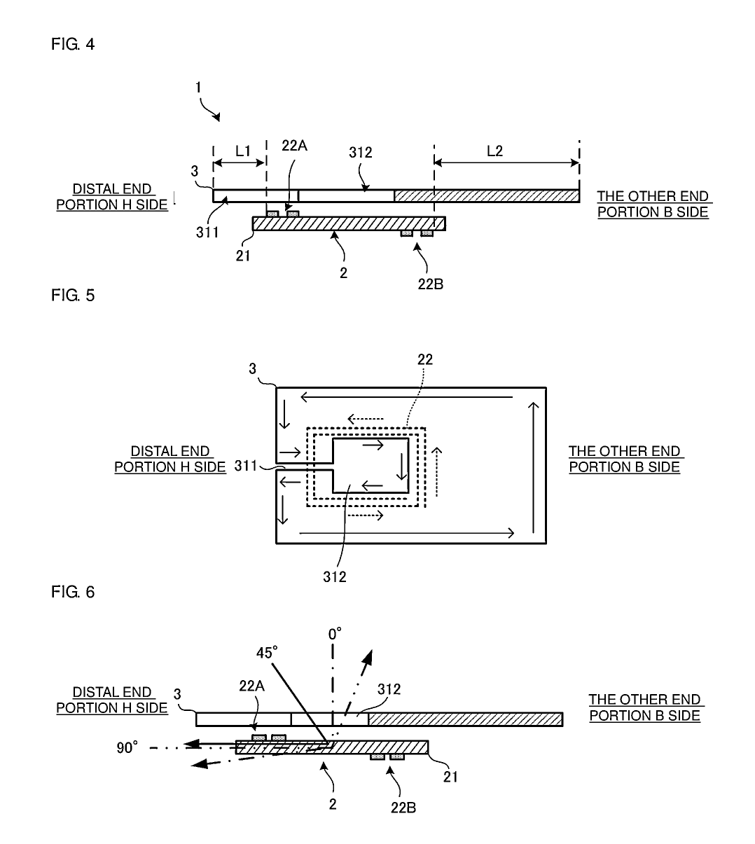

FIG. 3 is a perspective view of the RFID antenna 1 of the first embodiment. FIG. 4 is a cross-sectional view taken along line IV-IV of FIG. 3.

In this embodiment, the booster antenna 3 has a rectangular outer shape that extends long in one direction. When viewed from a thickness direction of the booster antenna 3, the booster antenna 3 is larger than the feeding coil 2. As illustrated in FIG. 1, the booster antenna 3 is disposed such that a longitudinal direction thereof coincides with a longitudinal direction of the communication terminal apparatus 10. The booster antenna 3 includes a slit (a first slit in the present invention) 311 penetrating the booster antenna 3 in the thickness direction, and a rectangular aperture 312 penetrating the booster antenna 3 in the thickness direction. The slit 311 is provided in the longitudinal direction from an end of the booster antenna 3 close to the distal end portion H of the communication terminal apparatus 10. The aperture 312 communicates with an outer side portion of the booster antenna 3 via the slit 311. While the length of the slit 311 and the size of the aperture 312 are not particularly limited, the aperture 312 is preferably disposed at a position closer to the distal end portion H of the communication terminal apparatus 10. That is, when the feeding coil 2 is located closer to the distal end portion H side of the booster antenna 3, the length of the slit 311 relatively decreases. Hence, the density of current flowing near the slit 311 increases. This can further improve directivity in a direction of the slit 311.

The feeding coil 2 is positioned such that the longitudinal direction of the magnetic core 21 coincides with the longitudinal direction of the booster antenna 3 and such that the first conductor part 22A is located close to the distal end portion H of the communication terminal apparatus 10. In the thickness direction of the booster antenna 3, the feeding coil 2 is disposed at a position such that at least a part of an opening serving as an inner portion where the coil conductor 22 is provided (hereinafter referred to as a coil opening) overlaps with the aperture 312, when viewed from the thickness direction. When a distance from the first conductor part 22A to the end of the booster antenna 3 on the distal end portion H side is taken as L1 and a distance from the second conductor part 22B to an end of the booster antenna 3 on the other end portion B side is taken L2, the feeding coil 2 is preferably disposed at a position such as to satisfy the relationship L1<L2. When the relationship L1<L2 is satisfied, the feeding coil 2 is located on the distal end portion H side of the RFID antenna 1. For this reason, the user can achieve high-gain communication by grasping the other end portion B of the communication terminal apparatus 10 and holding the distal end portion H over a communication partner. Particularly when an antenna of another system, such as the cellular phone antenna 122, is disposed in the other end portion B, the distance to the antenna can be increased, and therefore, there is little adverse effect between the antennas. Further, the feeding coil 2 also has directivity in the 0°-direction, the 90°-direction, and the 45°-direction. Therefore, for example, even when the center portion of the communication terminal apparatus 10 is held over the communication partner, high-gain communication can be achieved.

The feeding coil 2 may be disposed near the booster antenna 3 with a gap therebetween. Alternatively, the feeding coil 2 may be closely stuck to the booster antenna 3 with an adhesive or the like to integrate the feeding coil 2 and the booster antenna 3. In this case, since the feeding coil 2 can be located closer to the booster antenna 3, radiation efficiency of the booster antenna 3 can be enhanced further. Further, since integration can reduce characteristic variations, for example, the resonant frequency of the RFID antenna 1 can be designed easily.

FIG. 5 illustrates a path of current flowing through the coil conductor 22 of the feeding coil 2 and the booster antenna 3. By virtue of the structure in which the coil opening of the feeding coil 2 overlaps with the aperture 312, magnetic flux produced from the feeding coil 2 passes through the aperture 312 of the booster antenna 3. For this reason, in the aperture 312 of the booster antenna 3, large current is produced in a direction (solid arrows) opposite from a direction (broken arrows) of current flowing through the coil conductor 22 of the feeding coil 2. The current flowing around the aperture 312 passes around the slit 311 by an edge effect, and flows along the periphery of the booster antenna 3. In plan view, the direction of the current flowing along the periphery of the booster antenna 3 is the same as the direction of the current flowing through the coil conductor 22. For this reason, a magnetic field in the same direction as that of a magnetic field produced from the coil conductor 22 is produced from the booster antenna 3. Hence, the magnetic field from the booster antenna 3 is added to the magnetic field from the feeding coil 2, and this increases the communication distance. In this way, the magnetic flux produced from the coil conductor 22 of the feeding coil 2 and the booster antenna 3 interlinks with the antenna of the communication partner.

Particularly when the coil opening and the aperture 312 are substantially equal in size, when viewed from the thickness direction of the booster antenna 3, the coil conductor 22 is nearly aligned with a peripheral edge of the aperture 312 in the thickness direction, and this allows the magnetic field produced from the coil conductor 22 to efficiently pass through the aperture 312. For this reason, large current flows through the booster antenna 3, and the booster antenna 3 can efficiently radiate the magnetic field from the feeding coil 2.

The density of the current flowing through the booster antenna 3 becomes the highest at the slit 311. Since the magnetic field from the booster antenna 3 is also radiated in a forming direction of the slit 311, directivity of the RFID antenna 1 in the forming direction of the slit 311 can be improved. Since the RFID antenna 1 is disposed in the distal end portion H of the communication terminal apparatus 10 and the slit 311 is disposed in the distal end portion H, as described above, high-gain communication can be achieved by holding the distal end portion H over the communication partner.

FIG. 6 schematically illustrates directivity directions of the RFID antenna 1. As described above, the booster antenna 3 for improving the radiation characteristics of the feeding coil 2 in the RFID antenna 1 has the slit 311 and the aperture 312. The aperture 312 overlaps with the coil opening of the feeding coil 2, and opens closer to the other end portion B of the communication terminal apparatus 10 than the slit 311. With this structure, as illustrated by arrows in FIG. 6, the RFID antenna 1 has directivity in the 45°-direction in addition to the 0°-direction, the −∵°-direction, and the 90°-direction.

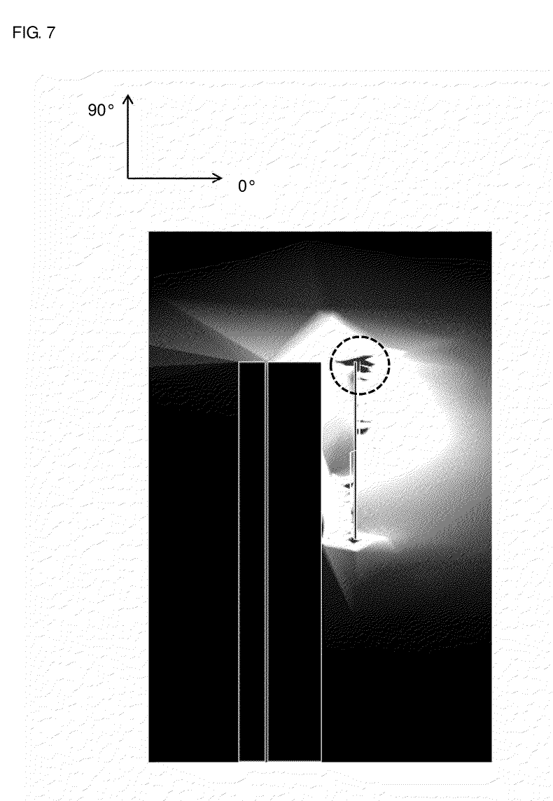

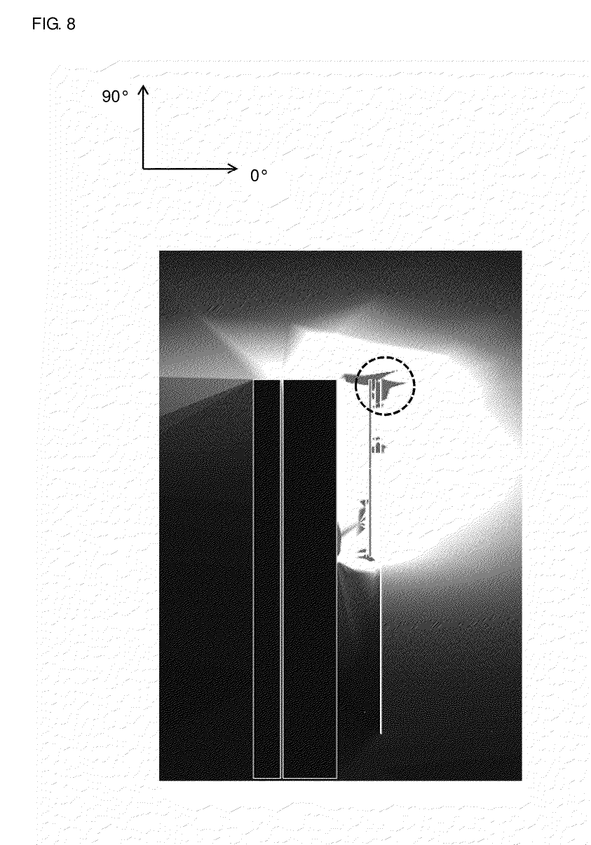

Simulation results of radiation characteristics of the RFID antenna 1 will be described below. FIG. 7 illustrates the magnetic field strength of the feeding coil 2 when the booster antenna 3 is not provided. FIG. 8 illustrates the magnetic field strength of the feeding coil 2 when the booster antenna 3 is provided. A rightward direction in the planes of FIGS. 7 and 8 is a 0°-direction. In FIGS. 7 and 8, the more the density of black in a circle is, the higher the magnetic field strength (A/m) is. Further, FIGS. 7 and 8 show that a magnetic field is radiated even in a light portion. Comparing FIG. 7 and FIG. 8, it is known that the magnetic field strength in the 45°-direction is higher when the booster antenna 3 is provided. Further, it is known that the magnetic field strength also becomes high and the communication distance increases in the 0°-direction, the −∵°-direction, and the 90°-direction.

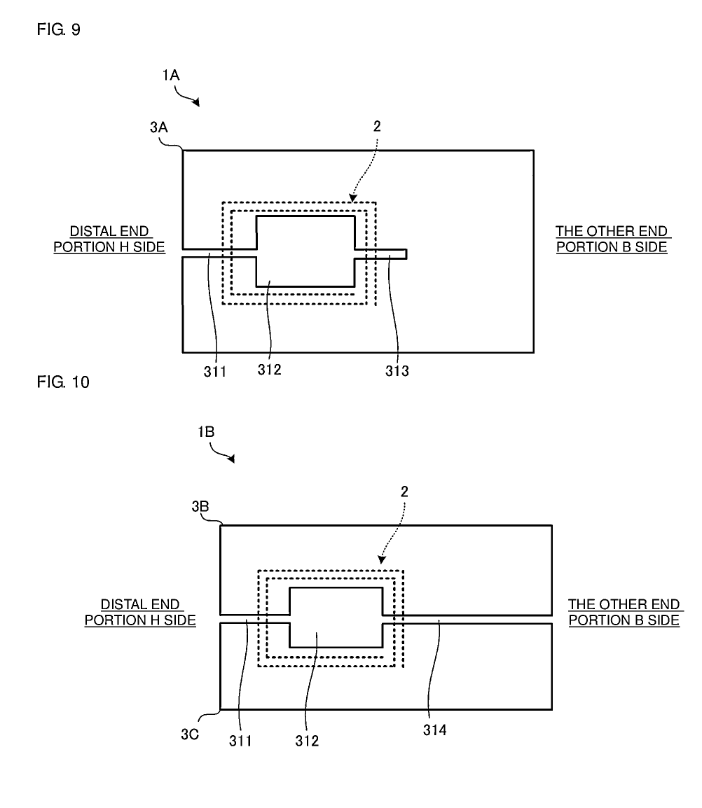

FIGS. 9 and 10 illustrate modifications of RFID antennas in each of which a slit is added to a booster antenna to further improve directivity. An RFID antenna 1A illustrated in FIG. 9 includes a booster antenna 3A having a slit 311, an aperture 312, and a slit 313, and a feeding coil 2. The slit 313 extends in almost the same straight line as that of the slit 311 in a longitudinal direction of the rectangular booster antenna 3A, and is connected at one end to the aperture 312, and is closed at the other end within a forming region of the booster antenna 3A. The slit 313 corresponds to a second slit in the present invention.

An RFID antenna 1B illustrated in FIG. 10 includes a booster antenna 3B composed of two metallic members 33 and 34, and a feeding coil 2. The metallic members 33 and 34 have the same shape, and are symmetrically arranged with a space therebetween to form a slit 311, an aperture 312, and a slit 314. The slit 314 has a structure such that the other end of the slit 313 illustrated in FIG. 9 is open on the other end portion B side.

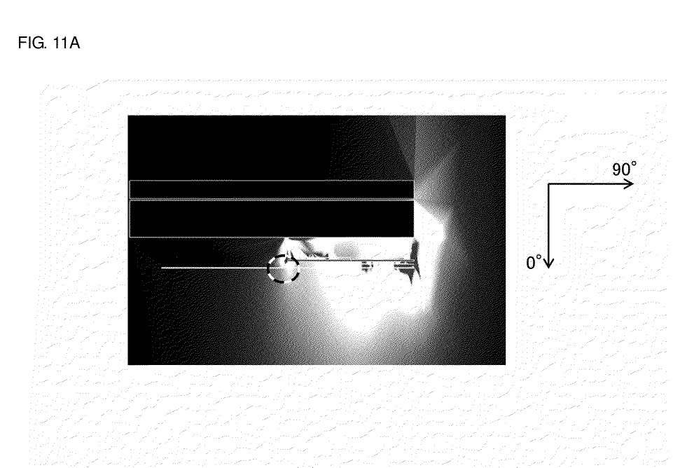

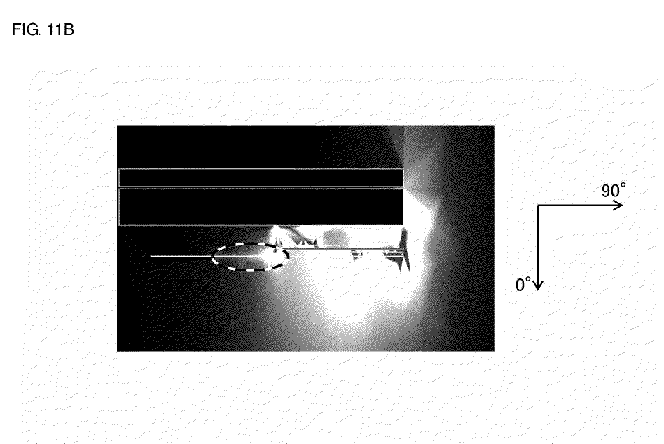

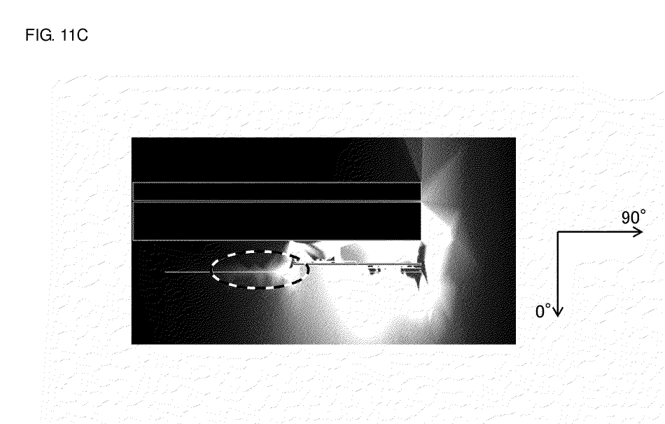

FIG. 11A illustrates the magnetic field strength of the feeding coil 2 illustrated in FIG. 8, FIG. 11B illustrates the magnetic field strength of the feeding coil 2 of the RFID antenna 1A illustrated in FIG. 9, and FIG. 11C illustrates the magnetic field strength of the feeding coil 2 of the RFID antenna 1B illustrated in FIG. 10. A low-density part in a broken circle in the figures represents the magnetic field strength in the other end portion B of the communication terminal apparatus 10. As known from FIGS. 11A, 11B, and 11C, directivity can be improved by forming the slit 313 or the slit 314.

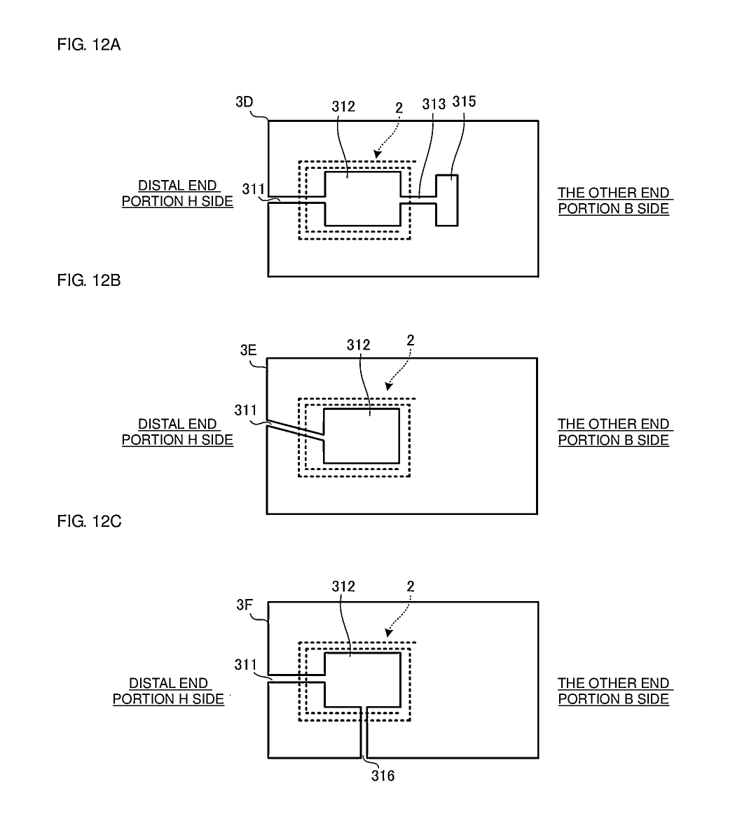

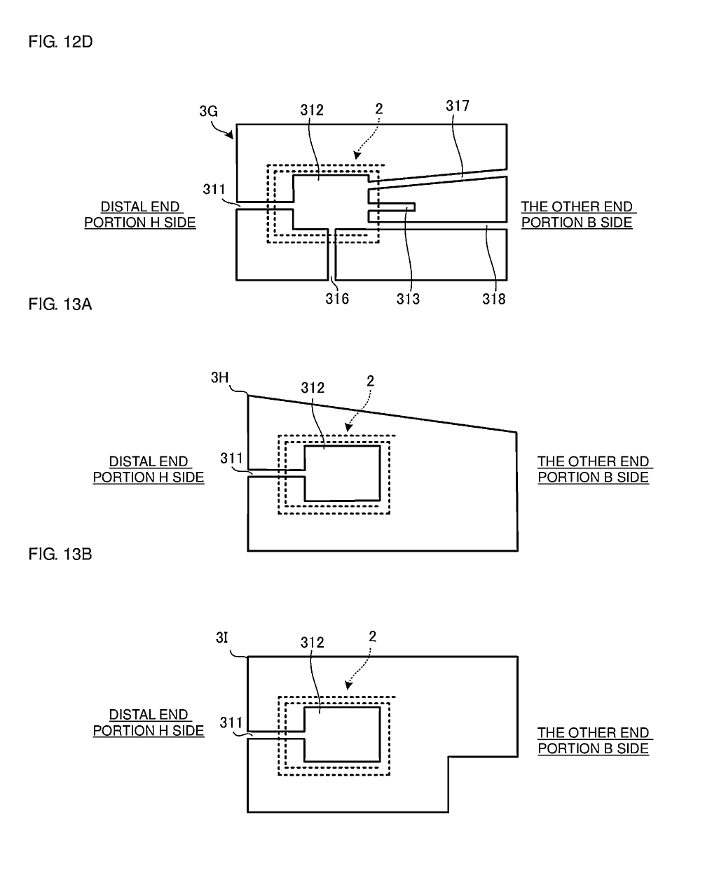

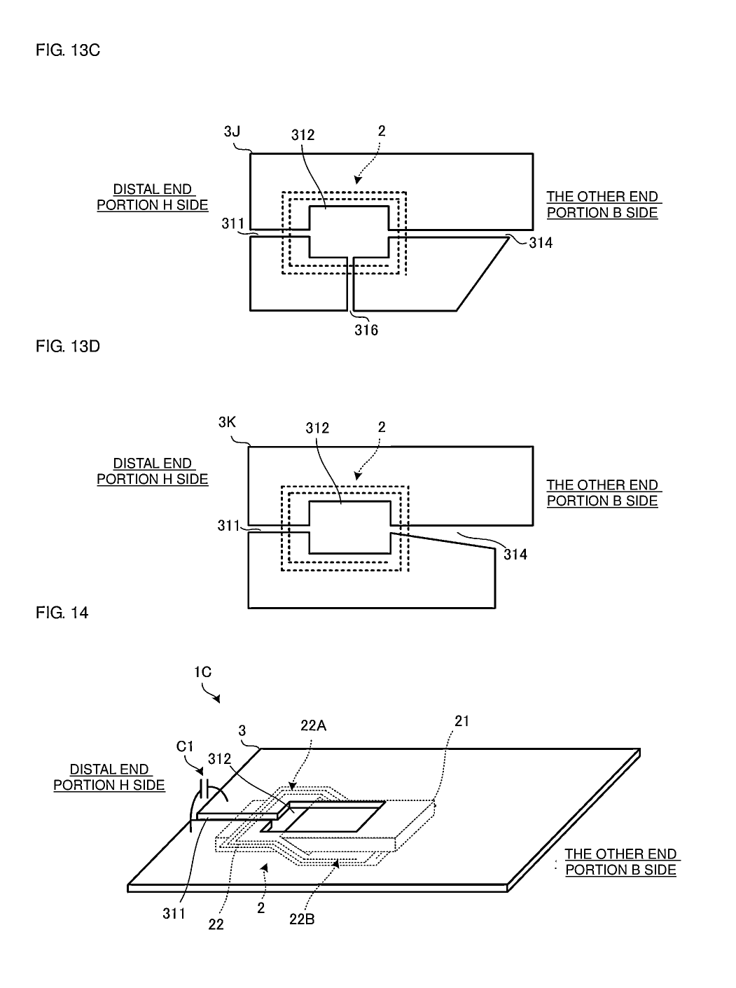

For example, the shape of the booster antenna and the shape of the slit formed in the booster antenna can be appropriately changed according to a desired directivity of the antenna device. Modifications of RFID antennas will be described below. FIG. 12A, FIG. 12B, FIG. 12C, and FIG. 12D and FIG. 13A, FIG. 13B, FIG. 13C, and FIG. 13D schematically illustrate modifications of booster antennas. These figures illustrate only a booster antenna and a feeding coil 2 in plan view.

As in a booster antenna 3D illustrated in FIG. 12A, a rectangular aperture 315 is further formed to communicate with an aperture 312 via a slit 313. In this case, current flowing in a width direction of the booster antenna 3D (a direction orthogonal to a longitudinal direction) increases, and this can further enhance the radiation efficiency. A slit 311 in a booster antenna 3E illustrated in FIG. 12B is tilted at an angle to a longitudinal direction. In this case, when another metallic member, electronic component, or circuit is disposed near the slit 311, the slit 311 is tilted to avoid the member, component, or circuit. This can prevent the slit 311 from being located close to another metallic member, electronic component, or circuit. Therefore, it is possible to prevent electromagnetic interference with these members and to serve as a shield.

A booster antenna 3F illustrated in FIG. 12C further includes a slit 316 extending in a width direction to be connected to an aperture 312. In this case, directivity can also be improved in a forming direction of the slit 316. A booster antenna 3G illustrated in FIG. 12D includes not only slits 311 and 313, but also slits 317 and 318 extending in a longitudinal direction to be connected to the aperture 312. In this case, directivity can also be improved in forming directions of the slits 311 and 313 and also in forming directions of the slits 316, 317, and 318.

A booster antenna 3H illustrated in FIG. 13A is trapezoidal. A booster antenna 3I illustrated in FIG. 13B and a booster antenna 3J illustrated in FIG. 13C are shaped like a rectangle with a part that is missing. These booster antennas can be positioned to avoid other mount components in a communication terminal apparatus 10. A slit 314 of a booster antenna 3K illustrated in FIG. 13D increases in width toward the other end portion B. Such a slit shape can prevent the slit 314 from overlapping with another metallic member, electronic component, or circuit.

The above-described concrete structures of the communication terminal apparatus 10 can be appropriately changed in design, and the operation and effect of the above-described embodiments are merely the most preferable exemplary operation and effect produced by the present invention. The operation and effect of the present invention are not limited to those of the above embodiments.

For example, while the housing 11 is formed of insulating resin, when the housing 11 is partly or entirely formed of metal, the metal portion may have the slit 311 and the aperture 312 to also function as the booster antenna 3. Further, the material of the booster antenna 3 is not particularly limited. For example, a magnesium alloy may be used. In this case, the strength of the housing 11 can be increased. While the RFID antenna 1 is disposed in the distal end portion H of the communication terminal apparatus 10, it may be disposed in the other end portion B, or may be disposed on the front side of the communication terminal apparatus 10. While the RFID antenna 1 is disposed such that the longitudinal direction of the magnetic core 21 coincides with the direction extending between the distal end portion H and the other end portion B of the communication terminal apparatus 10, the longitudinal direction of the magnetic core 21 may coincide with the width direction of the communication terminal apparatus 10. In this case, for example, when other antennas are disposed at ends of the distal end portion H and the other end portion H, interference with these antennas can be prevented. Further, the booster antenna 3 may further include an aperture or a cutout from which, for example, a lens of a camera module is exposed.

FIG. 14 illustrates another example of an RFID antenna according to the first embodiment. An RFID antenna 1C illustrated in FIG. 14 has a chip capacitor C1 provided in a booster antenna 3 to cross over a slit 311. The chip capacitor C1 serves to adjust the resonant frequency of the booster antenna 3. By providing the chip capacitor C1, communication sensitivity of the RFID antenna 1C can be increased.

The chip capacitor C1 may be a variable capacitor. For example, when a housing 11 has a metal portion and the metal portion includes a slit 311 and an aperture 312 to function as a booster antenna 3, the chip capacitor C1 may be mounted on a board 12 (see FIG. 1) and both ends of the chip capacitor C1 and both sides of the slit 311 may be contacted via spring pins or the like.

### Second Embodiment

In a second embodiment, the slit 311 and the aperture 312 of the first embodiment are replaced with one cutout.

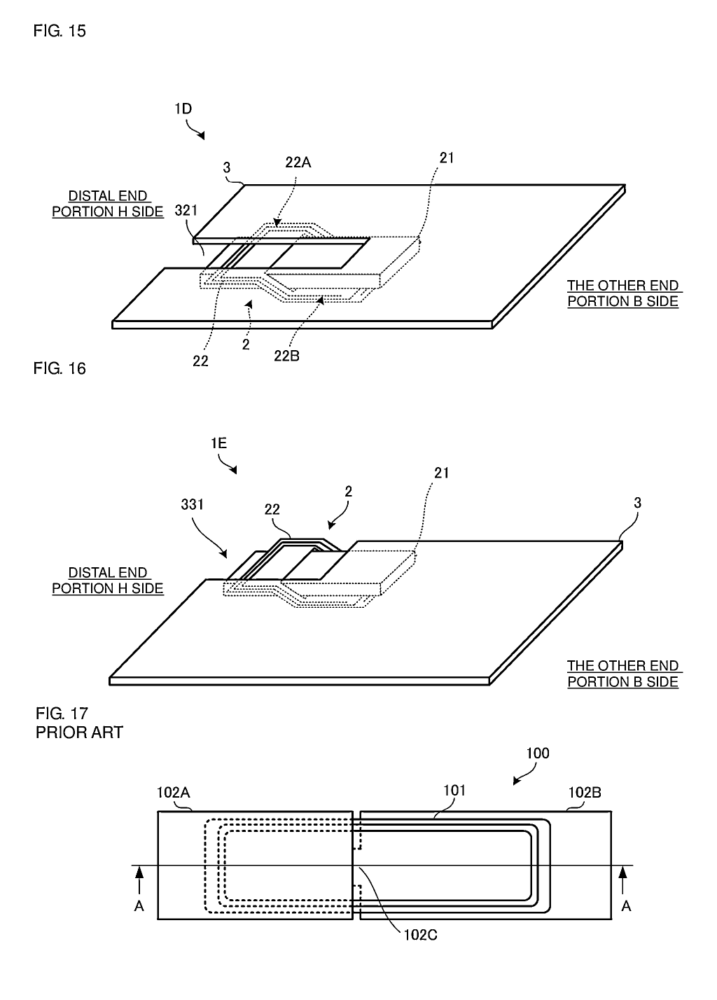

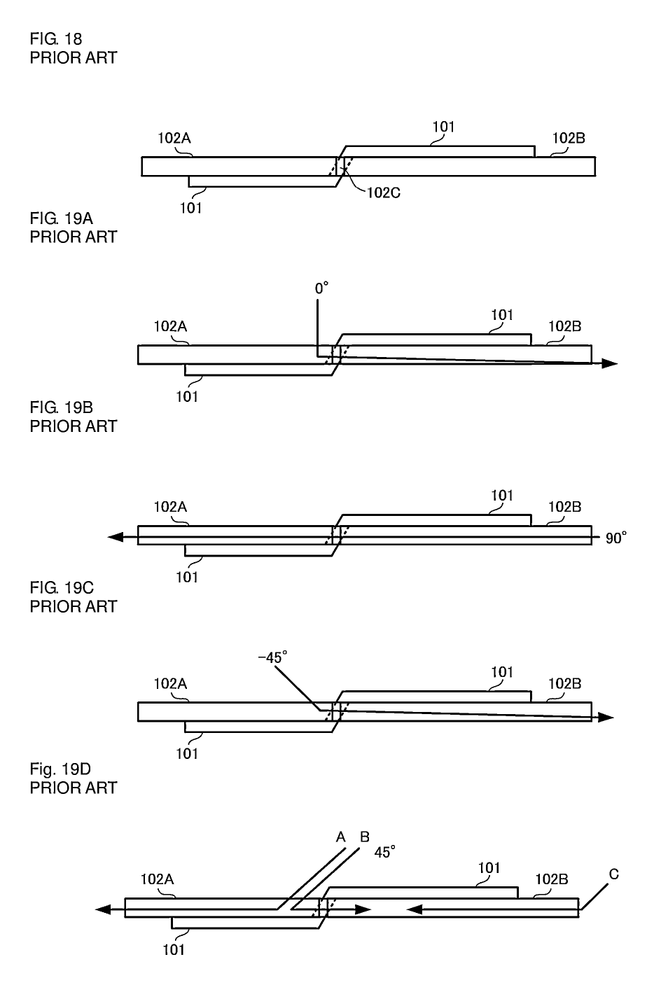

FIG. 15 is a perspective view of an RFID antenna 1D according to the second embodiment. A booster antenna 3 according to the second embodiment has a rectangular cutout 321 penetrating the booster antenna 3 in a thickness direction. The cutout 321 extends from an end of a distal end portion H of a communication terminal apparatus 10 toward a rear end portion B. By thus forming the rectangular cutout 321, a feeding coil 2 also has directivity in a forming direction of the cutout 321, that is, in a 45°-direction, similarly to the first embodiment. Therefore, for example, high-gain communication can be achieved even by holding the center portion of the communication terminal apparatus 10 over a communication partner.

The width and length of the cutout 321 are not limited. By increasing the width of the cutout 321, for example, another component, such as a camera module or a speaker of the communication terminal apparatus 10, can be disposed between a distal end portion H side of the cutout 321 and the feeding coil 2, and a space where the cutout 321 is formed can be utilized effectively. By decreasing the width of the cutout 321, the perimeter of the cutout 321 is relatively decreased, and the density of current flowing near the cutout 321 is increased. Hence, directivity in the direction of the cutout 321 can be improved further.

### Third Embodiment

In a third embodiment, similarly to the second embodiment, the slit 311 and the aperture 312 of the first embodiment are replaced with one cutout.

FIG. 16 is a perspective view of an RFID antenna 1E according to the third embodiment. A booster antenna 3 according to the third embodiment has a rectangular cutout 331 at one corner. A feeding coil 2 is disposed such that at least a part of an opening of a coil conductor 22 overlaps with the cutout 331 in plan view. By thus forming the rectangular cutout 331, the feeding coil 2 also has directivity in a forming direction of the cutout 321, similarly to the first and second embodiments. Therefore, for example, high-gain communication can be achieved even by holding the center portion of the communication terminal apparatus 10 over a communication partner. Further, since the cutout 331 is formed at the corner, production is facilitated.

1. An antenna device comprising:
a metallic member having a cutout that opens outside from at least one end portion; and
an antenna coil including a magnetic core having a first surface and a second surface opposed to each other, and a coil conductor wound around the magnetic core, at least a part of an opening of the coil conductor being disposed at a position overlapping with the cutout of the metallic member in a normal direction of the first surface and the second surface,
the coil conductor including a first conductor part located on the first surface of the magnetic core, and a second conductor part located on the second surface of the magnetic core, and the first conductor part and the second conductor part being wound around the magnetic core such as to be located at different positions in the normal direction of the first surface and the second surface, and
the antenna coil being disposed such that the first surface faces the metallic member and the first conductor part is located closer to the at least one end portion of the metallic member than the second conductor part.

2. The antenna device according to claim 1, wherein the cutout includes an aperture and a first slit extending from the aperture to the at least one end portion.

3. The antenna device according to claim 1, wherein a distance from the first conductor part to the at least one end portion is shorter than a distance from the second conductor part to another end portion opposed to the at least one end portion.

4. The antenna device according to claim 1, wherein the metallic member and the antenna coil are integrated.

5. The antenna device according to claim 2, wherein the metallic member further includes a second slit connected to the cutout.

6. The antenna device according to claim 1, further comprising:
a housing containing the antenna coil and the housing is partly or entirely formed by a metallic portion,
wherein the metallic member is the metallic portion of the housing.
